(19) United States
(12) Patent Application Publication
(10) Pub. No.: US 2009/0160674 A1
(43) Pub. Date: Jun. 25, 2009

(54) Wi-Fi enabled telemetry

(76) Inventor: Reddy R. Vangala, Albuquerque, NM (US)

Correspondence Address: Reddy Vangala, 9300 Saguaro St., NW, Albuquerque, NM, 87114, US

(21) Appl. No.: 12/004,268

(22) Filed: Dec. 20, 2007

(51) Int. Cl. G08C 19/16; G06F 17/00

(52) U.S. Cl. 340/870.01; 705/1

(57) ABSTRACT

A wireless telemetry system that leverages the ubiquitous Wi-Fi routers and public internet to communicate the level of propane in a tank to the propane distributor is disclosed. The system also allows the user of the fuel to monitor the level and modify the usage habits. Furthermore, the distributor can use the system to deliver the fuel efficiently. The system can also be used to monitor various utility meters for billing purposes wirelessly without the need to send personnel to the sites.

### TECHNICAL FIELD

This invention, in general, relates to a wireless system that can send various sensor and metering data from residential and commercial building sites to monitoring sites with the help of Wi-Fi and internet. In particular, this invention discloses a system which communicates the status of level of propane in a tank located at the customer premise to the distributor site automatically using Wi-Fi and public internet commonly available in residential and commercial buildings.

### BACKGROUND

In order to save labor and transportation costs, many propane distributors currently use proprietary wireless systems to sense the propane tank level remotely. Such systems typically employ a Hall-effect level sensor, a wireless transmitter attached to the tank which is located outside of the residential building and a wireless receiver, located inside the building, which receives the data from the transmitter and sends it over wired telephone line or a leased line to the server computer located at the third party monitoring service. The distributor has access to this data from the monitoring service via email, fax, or other means. When the propane level drops below a preset level, the server sets off an alarm and the distributor will send the refilling truck to fill up the tank. Such proprietary wireless systems are expensive and also require professional installation as well as a third party monitoring service. They are designed to do only one task, in this case monitoring the tank level. To do another task such as monitoring an electric utility meter they will have to be completely redesigned. Such lack of flexibility requires multiple systems to do multiple tasks. Further more the customer has no access to the data being monitored as a consequence the customer cannot optimize the system at will.

### SUMMARY

This invention overcomes problems of the prior art by leveraging standardized, inexpensive, and commonly available hardware; in most cases much of it already exists in the residential dwellings.

The present invention provides a flexible, inexpensive wireless sensing system to sense the tank level and send the data over the commonly available public internet. The Hall-effect sensor is similar to the prior art. However, unlike the prior art, the digital data generated by this sensor is fed to a Wi-Fi (an industry standard short range wireless protocol promoted by a trade group called Wi-Fi Alliance) transmitter which is a standardized commonly available technology. The data is transmitted using the standardized Wi-Fi protocol. Inside the building, unlike the prior art, the data will be received by a wireless router (a wireless router, in addition to acting as gateway to the residential internet access, allows sharing of the internet access amongst many computers and other appliances using short range wireless communication) which is commonly used for wireless internet access inside the building. Since this router already exists for common internet access, there's no additional expense is involved. The wireless router further sends the data to host PC (a computer that is directly hardwired to the router either through an USB or Ethernet connection) where a software client application allows the customer full control of the flow of the data. The customer can then choose to send the data to the propane distributor either manually or automatically. Unlike the prior art, the customer has full control of when and how the data is sent out to the distributor. For example, he can instruct the client application to automatically send it to the distributor's server over the standard internet as soon as a certain preset level is reached. Or he or she can enter the refill request on the distributor's website. The customer has full control. Since the transmitter and receiver are standard Wi-Fi hardware commonly available off the shelf, the system will be inexpensive. Since all of the sensors and meters can be made to work with Wi-Fi or other similar standards the system can be expanded to monitor other sensors and meters easily. The data is conveniently and securely sent to the server computer at the discretion of the customer.

Standardized Wi-Fi wireless link and use of internet will result in an inexpensive yet very flexible system that can be easily expanded. Most importantly the customer controls the flow of the data and the preset levels. The latter has the added benefit of requesting the refill when the fuel prices are more favorable. Also, since the customer has access to the utilization data, he or she has the option of optimizing the consumption to manage the budget better.

### BRIEF DESCRIPTION OF FIGURES

In the Figures,

FIG. 1 is an embodiment of prior art;

FIG. 2 is another embodiment of prior art.

FIG. 3 is a preferred embodiment of the present invention.

FIG. 4 is a flow chart of a method of distribution envisioned by the present invention.

### DETAILED DESCRIPTION OF THE INVENTION

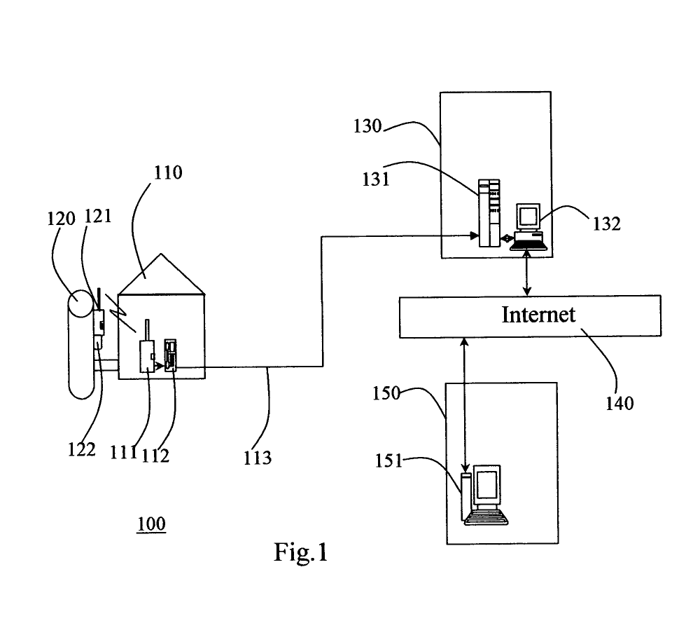

FIG. 1 refers to a prior art implementation 100. The residence 110 has a propane tank 120 on the premises. The propane tank is equipped with a sensor 122 that generates a signal proportional to the level of the propane in the tank. In some cases, the sensor generates an alarm signal when the propane level drops below preset limit. This signal will be fed to the transmitter 121 which wirelessly transmits it to the receiver 1 11 located inside 110. The receiver 111 in turn relays the signal to the server computer 131 located at a third party monitoring service building 130 by means of a modem 112 and landline 113. The computer 132 analyzes the data stored on 131 and generates a report to be sent to the propane distributor 150. The report may be sent to the distributor via any one of the commonly available communication means, for example internet 140. The report is received by the computer 151 and the distributor then dispatches a refilling truck to 110 to fill the tank 120 to proper level.

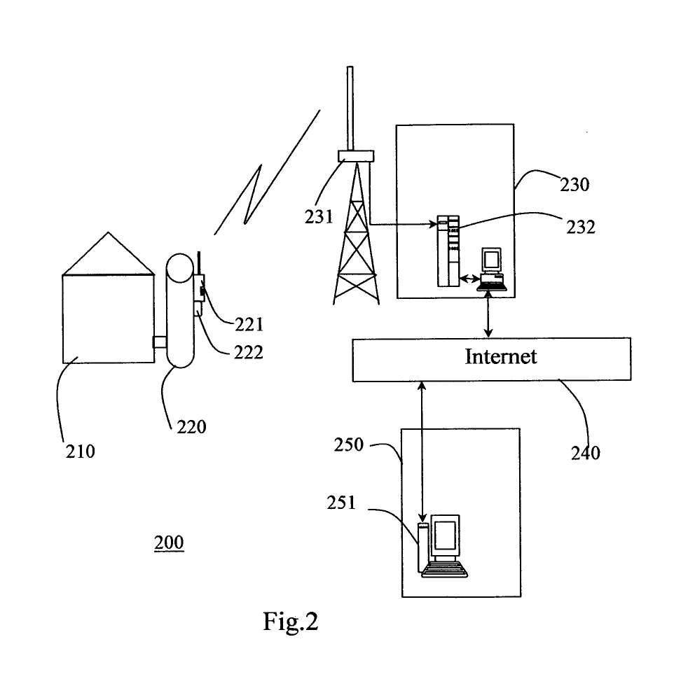

FIG. 2 refers to another implementation 200. This is very much similar to the 100, the only difference being the mode of transmission of the signal generated by the tank sensor 222. In this case the transmitter 221, with its antenna, directly and wirelessly transmits the signal to the receiver 231 located at the third party monitoring service building 230. Once again the monitoring service generates a report for the distributor and the distributor 250 will send the refilling truck to residence 210.

In both implementations the residential customer has little control of the decision loop of when the tank is refilled.

While this invention is susceptible to embodiment in many different forms, this specification and the accompanying drawings disclose only preferred forms as examples of the invention. The invention is not intended to be limited to the embodiments so described, however. The scope of the invention is identified in the appended claims.

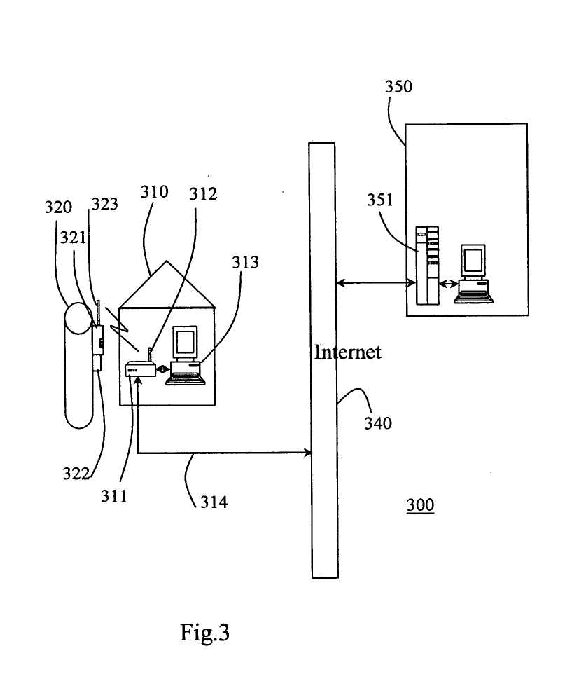

Referring to FIG. 3 residence 310 has a propane storage tank 320. The residence is equipped with internet service with the host computer 313. Furthermore the residence is equipped with a Wi-Fi wireless router 311 which has an antenna 312. Some routers are equipped with multiple antennas to improve the range of reception. This router provides wireless connection to other computers and appliances inside and nearby the residence using commonly known 802.11a/b/g/n protocols which are standards defined by the Institute of Electrical and Electronics Engineers. Such routers are capable of providing wireless internet access anywhere from a few hundred feet to over a 1000 feet. The sensor 322 generates a signal proportional to the level of the propane in the storage tank and sends the signal to the Wi-Fi enabled transmitter 321 which transmits the signal through its antenna 323. The transmitted signal is picked up by the Wi-Fi router 311 through its antenna 312. The host computer 313 stores the data and generates alarm and usage reports. Whenever an alarm is generated, the 313 will communicate it to the propane distributor 350 over the public internet 340 by means of the internet connection 314. The distributor's server 351 will disseminate the reports coming from various residential customers and then dispatches the refilling truck at proper schedules to minimize distribution costs.

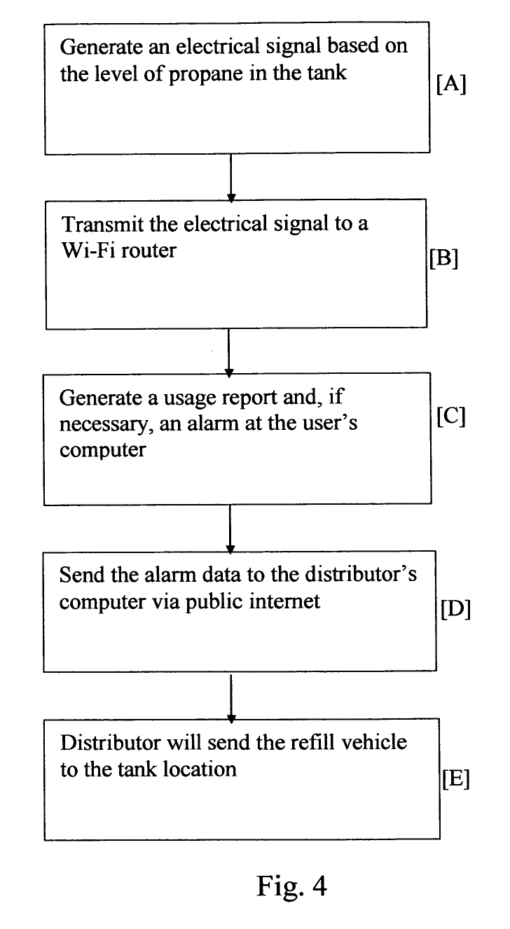

FIG. 4 depicts a preferred method of communicating the need for delivery of propane to a propane distributor. In step [A] the sensor attached to the propane tank generates an electrical signal which is indicative of the level of fuel left in the tank. In step [B] the electrical signal is wirelessly transmitted to a Wi-Fi receiver which is controlled by a host computer at the user's premise. In step [C] the host computer will generate a usage report and, if necessary, an alarm to indicate that the level of fuel has dropped below a preset point. This step allows the user to monitor the usage profile by the time of the day or day of the week or time of the year etc. This information coupled with the price of fuel at any given time, the user can make decision to replenish the fuel to save money and modify usage habits to maximize the savings. In step [D] the alarm will be communicated to the propane distributor via the internet. The client application software on the host computer at the customer's end can be set up to send the alarm: 1) automatically as it's generated, or 2) upon the approval of the user, or 3) user entering the alarm data on the distributor's website. In step [E] the distributor's server computer will evaluate the various alarms from different tanks and chart a proper delivery schedule and route to optimize the delivery costs.

Although the method is described for the delivery of propane fuel, it could just as well be used to monitoring the electric, water, gas and other utilities supplied by cities to its citizens. The utility company will save money by reducing the manpower needed to read meters on regular basis and the users of the utilities will greatly benefit from knowing the usage profile which allows them to modify their usage habits to minimize the costs and also indirectly reduce the environmental burden. Similarly, the system can be easily adapted to serving remote vending machines and such.

Numerous variations and modifications of the embodiment described above may be effected without departing from the spirit and scope of the novel features of the invention. It is to be understood that no limitations with respect to the specific system illustrated herein are intended or should be inferred. It is, of course, intended to cover by the appended claims all such modifications as fall within the scope of the claims.

I claim:

1. A wireless telemetry system consisting of:
a sensor that generates an electrical signal indicative of the level and or usage;
a wireless transmitter that takes the said electrical signal as input and then generates an output signal compatible with Wi-Fi (802.11a/b/g/n) transmission protocol;
a Wi-Fi wireless router that wirelessly receives the said output from the transmitter and stores on a host computer for subsequent transmission to a server computer located at a distant location over the public internet.

2. The wireless telemetry system of claim 1 wherein the said sensor generates an electrical signal that is either analog or digital.

3. The wireless telemetry system of claim 1 wherein the said sensor and the said transmitter are integrated into one unit.

4. The wireless telemetry system of claim 1 wherein the said Wi-Fi wireless router and the host computer are integrated into one unit.

5. The wireless telemetry system of claim 1 wherein the said transmitter and Wi-Fi router are operated in one or more of the designated Industrial Scientific and Medical unlicensed frequency bands

6. The wireless telemetry system of claim 1 wherein the transmitter and the said Wi-Fi wireless router are operated in any of the licensed bands permitted by respective government regulatory bodies.

7. The wireless telemetry system of claim 1 wherein the said output signal of the said transmitter is encrypted to provide privacy.

8. A wireless telemetry system consisting:
a sensor that generates an electrical signal indicative of the level and or usage;
a wireless transmitter that takes the said electrical signal as input and then generates an output signal compatible with Wi-Fi (802.11a/b/g/n) transmission protocol;
a Wi-Fi wireless router that wirelessly receives the said output from the transmitter and redirects it to a server computer located at a distant location over the public internet.

9. The wireless telemetry system of claim 2 wherein the said sensor generates an electrical signal that is either analog or digital.

10. The wireless telemetry system of claim 2 wherein the said sensor and the said transmitter are integrated into one unit.

11. The wireless telemetry system of claim 2 wherein the said transmitter and the said Wi-Fi wireless router are operated in one or more of the designated Industrial Scientific and Medical unlicensed frequency bands

12. The wireless telemetry system of claim 2 wherein the said transmitter and said Wi-Fi wireless router are operated in any of the licensed bands permitted by respective government regulatory bodies.

13. The wireless telemetry system of claim 2 wherein the said output signal of the said transmitter is encrypted to provide privacy.

14. A method of delivering propane to users consisting of:
Step [A]: generate an electrical signal indicative of the level of fuel in a tank;
Step [B]: transmit the said electrical signal to a Wi-Fi router;
Step [C]: based on the said electrical signal, generate a usage report and, if necessary, an alarm at the user's computer;
Step [D]: communicate the said alarm data to the distributor's server computer via public internet;
Step [E]: in response to the said alarm data, the distributor sends a refill vehicle to the tank location.
